(19) United States
(12) Patent Application Publication
(10) Pub. No.: US 2013/0232124 A1
(43) Pub. Date: Sep. 5, 2013

(54) DEDUPLICATING A FILE SYSTEM

(71) Applicant: Blaine D. GAITHER, Fort Collins, CO (US)

(72) Inventor: Blaine D. GAITHER, Fort Collins, CO (US)

(21) Appl. No.: 13/412,146

(22) Filed: Mar. 5, 2012

(51) Int. Cl. G06F 7/00

(52) U.S. Cl. 707/692; 707/E17.01; 707/E17.002

(57) ABSTRACT

A storage node receives a file. The storage node determines whether the file is stored on the storage node by comparing a hash value computed for content of the received file to hash values for content stored on the storage node. The storage node transfers a name and address of the file to a directory node.

### BACKGROUND

One important component of a computing system is the file system. Files are data stored in a predetermined structure. The file system organizes data into files and manages the location, storage, and access of the files. Enterprise class and other distributed computing systems often include a distributed file system. A distributed file system is a file system in which files are shared and distributed across computing resources. Such file systems are also called cluster file systems.

### BRIEF DESCRIPTION OF THE DRAWINGS

For a detailed description of various examples of the invention, reference will now be made to the accompanying drawings in which:

FIG. 1 shows a block diagram of a system for deduplicating a cluster file system in accordance with principles disclosed herein;

FIG. 2 shows a flow diagram for a method for deduplicating a cluster file system in accordance with principles disclosed herein; and

FIG. 3 shows a flow diagram for a method for deduplicating a cluster file system in accordance with principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The recitation “based on” is intended to mean “based at least in part on.” Therefore, if X is based on Y, X may be based on Y and any number of additional factors.

### DETAILED DESCRIPTION

The following discussion is directed to various implementations of an efficient deduplicating cluster file system. The principles disclosed have broad application, and the discussion of any implementation is meant only to illustrate that implementation, and not intended to intimate that the scope of the disclosure, including the claims, is limited to that implementation.

In a cluster file system, a plurality of computing devices may be dedicated to file storage. Such computing devices are herein termed “storage nodes.” Files stored in the cluster file system may be scattered across the storage nodes. Multiple copies of a file may be stored in the cluster file system. For example, use of a data file by multiple applications or users may result in storage of multiple copies of the file. Storage of multiple copies of a file across the cluster file system needlessly wastes storage resources. Furthermore, because semiconductor storage devices such as FLASH memory employed by the storage nodes have limited endurance, needlessly writing multiple copies of a file shortens the working life of the storage nodes.

The deduplicating cluster file system disclosed herein improves file system storage efficiency by ensuring that multiple copies of an identical file are not stored anywhere in the file system. That is, in some implementations, only a single copy of a particular file exists in the cluster file system. By ensuring that multiple copies of a file are not written to storage, the deduplicating cluster file system disclosed herein also reduces the wear on semiconductor storage devices, thereby increasing the useful life of the storage nodes. Various implementations of the deduplicating cluster file system provide balanced utilization of storage resources by randomizing file storage location across the storage nodes of the cluster file system. As used herein, the term “deduplicating” and the like refer to the elimination of multiple instances of a file, and the term “file” refers to a file or a portion thereof, such as a block of file content.

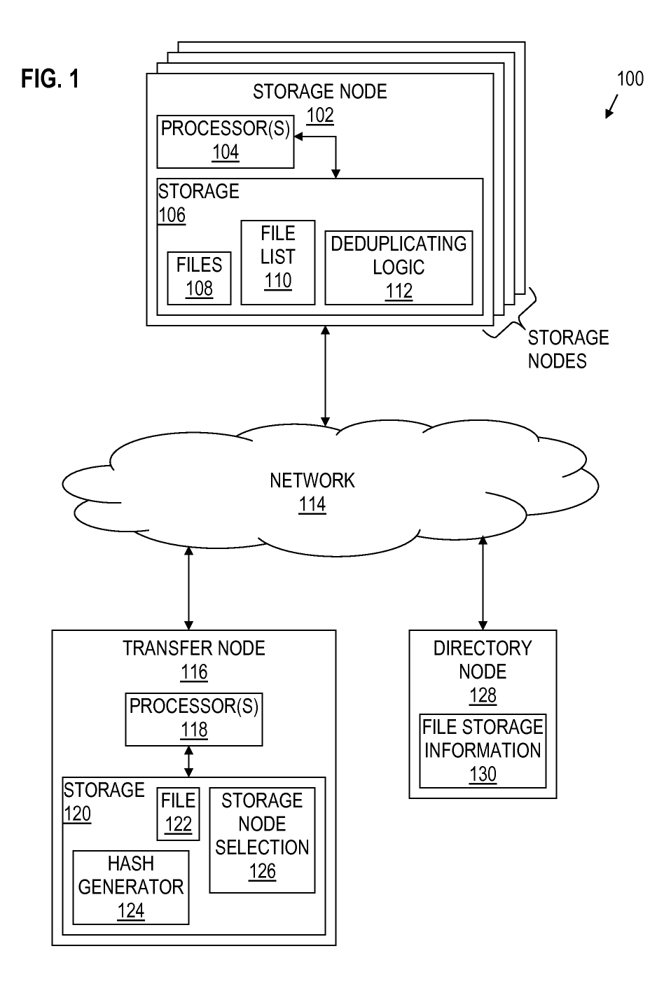

FIG. 1 shows a block diagram of a system 100 for deduplicating a cluster file system in accordance with principles disclosed herein. The system includes a plurality of storage nodes 102, a transfer node 116, and a directory node 128 communicatively coupled via a network 114. The network 118 any network capable of communicatively coupling the node 102, 116, 128. For example, the network 118 may be a local area network, a wide area network, a metropolitan area network, the internet, or any other suitable network, and combinations thereof.

The nodes 102, 116, 128 may be implemented using any type of computing device capable of performing the functions disclosed herein. For example, the nodes 120, 116, 128 may be implemented using personal computers, server computers, or other suitable computing devices.

The storage nodes 102 provide storage for the cluster file system and include processor(s) 104 coupled to storage 106. The processor(s) 104 may include, for example, one or more general-purpose microprocessors, digital signal processors, microcontrollers, or other devices capable of executing instructions retrieved from a computer-readable storage medium. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 106 is a non-transitory computer-readable storage medium and may include volatile storage such as random access memory, non-volatile storage (e.g., a hard drive, an optical storage device (e.g., CD or DVD), FLASH storage, read-only-memory), or combinations thereof. In some implementations of the storage node 102, the storage 106 may be local to the processor(s) 104. In other implementations, the storage 104 may be remote from the processor(s) 104 and accessed via a network, such as the network 114.

The storage 106 includes files 108 stored by the cluster file system, a file list 110 identifying the files 108, and deduplicating logic 112. In some implementations, the file list 108 may include a hash value, an address, and a reference count value for each file content stored in the storage 108 of the storage node 102. The hash value is computed by applying a hash function to the content of the corresponding file (i.e., computing a hash value for the content portion of the file as opposed to a non-content portion of the file, such as the file name or file metadata). The address identifies the location where the file is stored on the storage node 102. The reference count value is associated with the file content and/or the storage allocated to the file content, and indicates the number of files stored on the storage node 102 that share the file content.

In some implementations, the deduplicating logic 112 includes instructions that are executed by the processor(s) 104 to manage the files 108 and to ensure that no duplicate files are stored on the storage node 102. Each file transferred to the storage node 102 for storage is transferred in conjunction with a hash value computed for the content of the file. The deduplicating logic 112 compares the hash value received in conjunction with a file transferred to the storage node 102 to the hash values stored in the file list 110. Based on the comparison, the deduplicating logic 112 determines whether the received file may be already stored on the storage node 102. If a hash match is found, and no files having content different from that of the transferred file have the same hash value as the transferred file (i.e., there are no hash collisions), then, if the hash is strong, the deduplicating logic 112 may determine that the file is already stored on the storage node and need not be stored again. If no hash match is found, then the deduplicating logic allocates storage space and stores the file on the storage node 102.

If a hash match is found via the comparison, but there are hash collisions, then the deduplicating logic may compare the content of the received file to the content of files corresponding to the matching hash value stored on the storage node 102 to determine whether the received file contents are already stored on the storage node 102. As disclosed above, if a previously stored duplicate file is identified, then the received file is not stored. Otherwise, storage space is allocated and the received file is stored on the storage node 102.

The deduplicating logic 112 stores the received hash value, the storage address, and reference count value corresponding to the file content and/or storage of the received file in the file list 110. The reference count is incremented if the received file content is shared by a different file. In some implementations, the name of the file may also be stored in the file list.

The directory node 128 includes file storage information 128. The file storage information 128 identifies the storage location of each file stored in the cluster file system. For example, the file storage information may include a file name, hash value, storage node, and/or address for each file. The file storage information may be accessible via file name. When the deduplicating logic 112 stores a received file on the storage node 102, the deduplicating logic transmits file location information, such as file name, hash value, storage node identification, file address, etc. to the directory node 128 for storage and access by various components of and/or communicating with the system 100.

The transfer node 116 is a node of the cluster file system that transfers a file to a storage node 102 for storage. For example, the transfer node 116 may be a computing device associated with a file cache that stores files read from the storages nodes 102 for quick access, and executes write-back of the cached files to the storage nodes 102. More generally, the transfer node 116 may be any computing device that is communicatively coupled to and provides a file to a storage node 102 for storage. In some implementations, any of transfer nodes 116, directory node 128, and storage node 102 may be collocated.

The transfer node 116 includes processor(s) 118 and storage 120. The processor(s) 118 may be similar to those described with regard to the processor(s) 104, and the storage 120 may be as described with regard to the storage 106. The storage 120 includes a hash value generator 124, storage node selection logic 126, and a file 122 that is to be transferred to a storage node 102. The hash generator 124 and the storage node selection logic 126 include instructions that when executed cause the processor(s) 118 to perform the functions disclosed herein.

When the file 122 is to be moved from the transfer node 116 to a storage node 102, the transfer node 116 uses the hash generator 124 to apply a hash function to and compute a hash value for the content of the file 122. That is, a hash value is generated for the file content rather than or in addition to the file name. Based on the generated hash value, the storage node selection logic 126 identifies one of the storage nodes 102 as the destination to which the file 122 will be transferred for storage. For example, the storage node selection logic 126 may select a storage node based on the value of a predetermined set of digits of the hash value (e.g., a sub-field of the hash value may provide a storage node index value).

Because the hash generator 124 produces the same hash value for duplicate file content, the same storage node 102 is always selected for duplicate files, thereby providing deduplication across the entirety of the cluster file system. Furthermore, the randomness of the hash value based on file content serves to randomly distribute files across the cluster file system, thereby promoting uniform wear of semiconductor storage devices.

When the content of a file 122 changes, the hash value generated by the hash generator 124 for the file 122 will be different from the hash value generated for the previous version of the file. Consequently, the storage node selection logic 126 may cause the modified file 122 be stored in a different storage node 102 than the previous version of the file 122. The storage node 102 storing the previous version of the file 122 may be notified that the location of the file 122 is changing and deallocate the space assigned to the previous version of the file 122 accordingly. For example, the directory node 128, when storing the file location information provided by the storage node 102 as described herein, determines that the location of the file 122 has changed, and sends a message, or otherwise notifies, the storage node 102 storing the previous version of the file 122 of the location change. In response the storage node 102 storing the previous version of the file 122 may decrement the reference counter associated with the moved file, and deallocate the storage assigned to the file 122 if the reference counter indicates that the storage is not shared by another file (e.g., the reference counter is decremented to zero). In some implementations of the system 100, the transfer node 116 or the storage node 102 may notify the storage node 102 storing the previous version of the file 122 that the file 122 is being moved. Thus, implementations of the system 100 maintain a single copy of the file 122 across the entirety of the cluster file system.

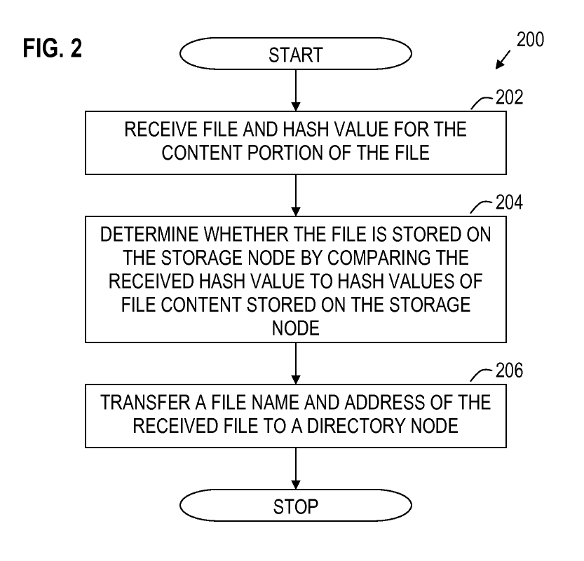

FIG. 2 shows a flow diagram 200 for a method for deduplicating a cluster file system in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 200 can be performed by processor(s) (e.g., processor(s) 104) executing instructions retrieved from a computer a computer-readable medium (e.g., storage 106).

In block 202, the transfer node 116 is transferring the file 122 to a storage node 102. The transfer node 116 selected the storage node 102 based on a hash value computed for the content of the file 122. The storage node 102 receives the file 122 and the corresponding hash value transmitted by the transfer node 116.

In block 204, the storage node 102 determines whether the received file is already stored on the storage node 102. The determination involves comparing the hash value received from the transfer node 116 to hash values of file content already stored on the storage node 102.

In block 206, the storage node 102 has allocated storage for the file 122 and stored the file 122 in the allocated storage. The storage node 102 transmits the name of the file 122 and an address value indicating where the file 122 is stored to the directory node 128 for storage and access by other devices using the cluster file system.

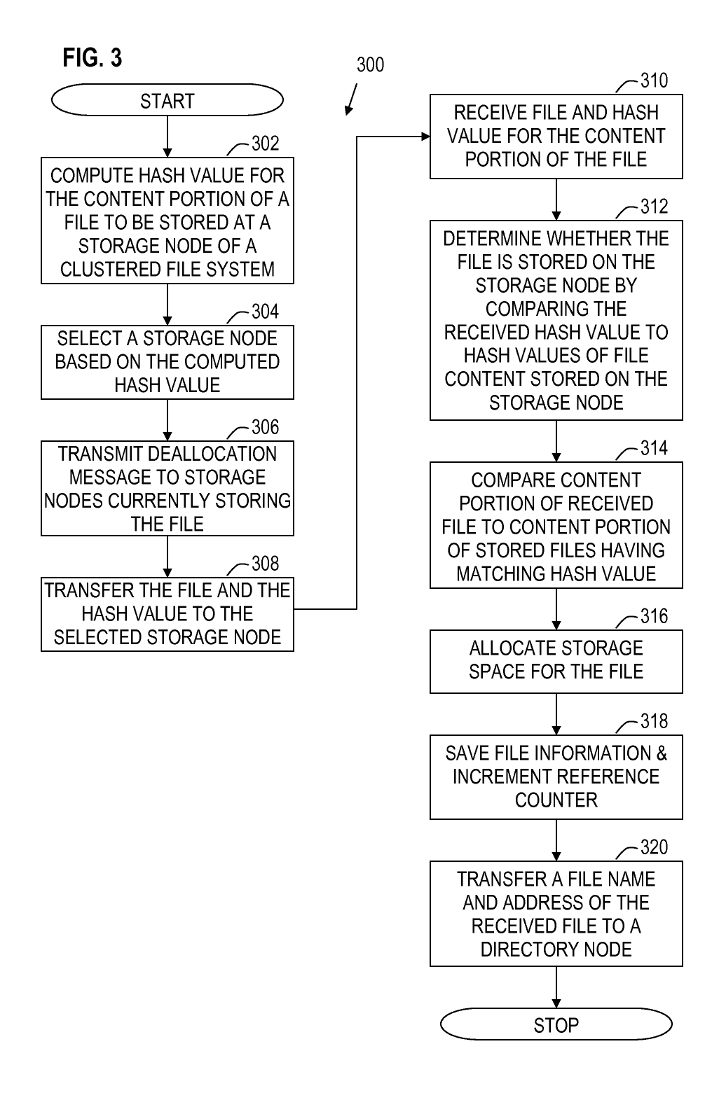

FIG. 3 shows a flow diagram 300 for a method for deduplicating a cluster file system in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 300 can be performed by processor(s) (e.g., processor(s) 104) executing instructions retrieved from a computer a computer-readable medium (e.g., storage 106).

In block 302, the transfer node 116 determines that the file 122 is to be stored in higher level storage at one of the storage nodes 102 of the clustered file system. The transfer node 116 applies a hash function to the content of the file 122 to compute a hash value corresponding to the content of the file.

In block 304, the transfer node 116 selects a storage node 102 to which to transfer the file 122 for storage. The transfer node 116 selects the storage node 102 based on the hash value computed for the content of the file. For example, a predetermined field or set of symbols of the hash value may represent a storage node index that identifies a storage node 102 that is to store the file 122.

In block 306, the transfer node 116 transmits a deallocation message to a storage node 102 storing a previous version of the file 112. The deallocation message notifies the storage node 102 that the file 122 is being moved to a different storage node 102 (i.e., the storage node 102 selected based on the hash value). The deallocation message may trigger the receiving storage node 102 to deallocate the storage assigned to the previous version of the file 122. In other implementations, the deallocation message may be sent by the storage node receiving the file 122 for storage, by the directory node 128, or by another node of the system 100.

In block 308, the transfer node 116 transfers the file 122 and the hash value computed for the content of the file 122 to the selected storage node 102. The storage node 102 receives the file 122 and the corresponding file content hash value in block 310.

In block 312, the storage node 102 determines whether the received file 122 is already stored on the storage node 102. The determination involves comparing the hash value received from the transfer node 116 to hash values of file content already stored on the storage node 102. The storage node 102 maintains a list of hash values and corresponding storage addresses for files stored on the storage node 102.

A hash collision occurs when two files having different content hash to the same hash value. In block 314, if a hash collision is detected by the storage node 102, then the storage node 102 compares the content of the received file 122 to the content of each file stored on the storage node 102 that hashes to the received hash value to determine whether the received file content is already stored on the storage node 102.

In block 316, if the storage node 102 determines that the received file 122 is not already stored on the storage node 102, then the storage node 102 allocates storage for the file 122 and stores the file therein. If the storage node 102 determines that the received file 122 is already stored on the storage node 102, then the received file 122 is a duplicate and no additional storage is allocated for the file 122.

In block 318, if storage is allocated and the file 122 stored, then the storage node 102 stores information related to the file 122 in the file list 110. The information may include the received hash value, the storage address, and a reference counter corresponding to the file content and/or the storage allocated to the file. If the received content is identical to that of a different file stored in by the storage node 102, then the reference counter corresponding to the file content and/or the file storage location is incremented, indicating that the content applies to more than one file stored on the storage node 102.

In block 320, the storage node 102 has allocated storage for the file 122 and stored the file 122 in the allocated storage. The storage node 102 transmits the name of the file 122 and an address value indicating where the file 122 is stored to the directory node 128 for storage and access by other nodes using the cluster file system.

The above discussion is meant to be illustrative of the principles and various implementations of the present invention. Numerous variations and modifications will become apparent to those skilled in the art once the above disclosure is fully appreciated. It is intended that the following claims be interpreted to embrace all such variations and modifications.

1. A method for deduplicating a file system, comprising:
receiving, by a storage node, a file;
determining, by the storage node, whether the received file is stored on the storage node by comparing a file content hash value computed for a content portion of the received file to hash values of content portions of files stored on the storage node;
transferring, by the storage node, a file name and address of the received file on the storage node to a directory node that maintains a list of files and corresponding locations.

2. The method of claim 1, wherein the determining further comprises comparing the content portion of each file on the storage node having a hash value that matches the file content hash value to the content portion of the received file.

3. The method of claim 1, further comprising allocating storage space for the file based on the comparing indicating that the received file is not stored on the storage node.

4. The method of claim 1, further comprising incrementing a reference counter associated with the file content hash value based on the file content hash value matching a hash value of a different file stored on the storage node.

5. The method of claim 1, further comprising:
computing the file content hash value for the content portion of the file;
selecting, based on the file content hash value, the storage node from a plurality of storage nodes;
transferring the file to the storage node; and
optionally, transferring the file content hash value to the storage node.

6. The method of claim 1, further comprising transmitting a message to a given storage node; wherein the given storage node stores a previous version of the file and a different hash value for the file; and wherein the message causes the given storage node to decrement a reference counter associated with the file, and deallocate the storage space occupied by the previous version of the file based on the reference counter being decremented to zero.

7. The method of claim 1, further comprising discarding the received file based on the comparing determining that the received hash value and content matches one of the hash values of content portions of files stored on the storage node.

8. A system, comprising:
a storage node, comprising:
file storage;
a file storage list, comprising:
a stored file content hash value;
a file address for each file having content that hashes to the file content hash value; and
a reference count indicating the number of files having content that hashes to the file content hash value;
deduplicating logic to:
receive a file to be stored on the storage node;
determine whether the file is written to the file storage by comparing a file content hash value computed for a content portion of the received file to the file content hash value of the file storage list;
transfer a file name and address of the received file to a file directory node that maintains a list of files and corresponding locations for a cluster file system.

9. The system of claim 8, wherein the deduplicating logic is to compare the content portion of each file of the file storage having a stored file hash value that matches the file content hash value to the content portion of the received file.

10. The system of claim 8, wherein the deduplicating logic is to allocate storage space for the file based on the comparing indicating that the received file is not stored in the file storage.

11. The system of claim 8, wherein the deduplicating logic is to increment a reference counter associated with the received file based on the content portion of the received file matching a content portion of a different file stored in the file storage.

12. The system of claim 8, wherein the deduplicating logic is to discard the received file based on a determination that the content portion of the received file is identical to a content portion of a different file stored in the file storage.

13. The system of claim 8, further comprising:
a transfer node to:
compute the file content hash value for the content portion of the file received by the storage node;
select, based on the file content hash value, the storage node from a plurality of storage nodes of the cluster file system;
transmit the file and, optionally transmit, the hash value to the storage node.

14. The system of claim 13, wherein at least one of the transfer node, the storage node, and the directory node is further to transmit a message to a given storage node; wherein the given storage node stores a different version of the file received by the storage node and a different hash value for the different version of the file; and wherein the message causes the given storage node to decrement a reference counter associated with the different version of the file, and to deallocate the storage space occupied by the different version of the file based on the reference counter being decremented to zero.

15. The system of claim 13, wherein the transfer node and the storage node are to prevent storage of duplicate files in the cluster file system based on the file content hash value.

16. A deduplicating cluster file system, comprising:
a transfer node to:
transfer files to storage nodes of the cluster file system; and
ensure that no two storage nodes store an identical file;
the transfer node is further to:
compute a file content hash value for a content portion of a file to be transferred to a storage node;
select, based on the file content hash value, a storage node to which the file is to be transferred; and
transmit the file and the hash value to the selected storage node.

17. The file system of claim 16, wherein each storage node is to:
store files of the cluster file system; and
prevent storage of multiple copies of file content on the storage node; and
each storage node is further to:
receive a file transmitted to the storage node by the transfer node;
determine whether the file is already stored on the storage node by comparing the file content hash value to hash values of content portions of files stored on the storage node;
compare the content portion of each file on the storage node having a hash value that matches the file content hash value to the content portion of the received file based on the hash value not uniquely identifying the file;
allocate storage space for the file based on the comparing indicating that the received file is not already stored on the storage node;
transfer a file name and address of the received file on the storage node to a directory node that maintains a list of files and corresponding locations.

18. The file system of claim 16, wherein each storage node is further to:
receive an indicator corresponding to a given file stored on the storage node;
decrement a reference counter corresponding to storage space occupied by the given file; and
deallocate the storage space occupied by the given file based on the reference counter being decremented to zero.

19. The file system of claim 16, wherein each storage node is further to increment a reference counter associated with the file content based on detection identical content stored on the storage node.

20. The method of claim 1, further comprising promoting uniform wear of semiconductor storage devices of storage nodes by randomly distributing files to the storage nodes based on a predetermined subset of symbols of the file content hash value.
